(19) United States
(12) Patent Application Publication
(10) Pub. No.: US 2008/0308340 A1
(43) Pub. Date: Dec. 18, 2008

(54) Transaxle

(76) Inventor: Shuji NISHIMOTO, Hyogo (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/828,415

(22) Filed: Jul. 26, 2007

(30) Foreign Application Priority Data
Jul. 26, 2006 (JP) 2006-204008

(51) Int. Cl. B60K 17/16

(52) U.S. Cl. 180/378

(57) ABSTRACT

In a transaxle, a transaxle housing includes a first divisional housing member and a second divisional housing member joined to each other. A transmission is disposed in the first divisional housing member. An axle is disposed in the mutually joined first and second divisional housing members and drivingly connected to the transmission in the first divisional housing member. A brake device is provided on the axle. The second divisional housing member is formed integrally with a brake chamber portion joined to the first divisional housing member so as to incorporate the brake device in the brake chamber portion. The transaxle is provided with a power take-off device for taking off power from the transmission, including a power take-off casing. A connection shaft is interposed between the transmission and the power take-off device. The second divisional housing member is formed integrally with a mount portion expanded from the brake chamber portion radially with respect to the axle. The power take-off casing is mounted onto the mount portion. The connection shaft is passed through the mount portion between the first divisional housing member and the power take-off casing.

### BACKGROUND OF THE INVENTION

1. Field of the Invention

The present invention relates to a transaxle comprising a transaxle housing, in which a transmission, an axle driven by the transmission, and a considerably large brake device, such as a wet brake, provided on the axle are disposed, and a power take-off device mounted on a side of the transaxle housing so as to take off power from the transmission.

2. Related Art

As disclosed in JP 2000-38042 A, there is a well-known conventional transaxle whose transaxle housing comprises a plurality of divisional housing members, that is, a pair of left and right mutually joined main housing halves, a pair of left and right axle casings containing respective axles, and a pair of intermediate casings each of which covers a space between the axle casing and the main housing half. The transaxle includes a power take-off device (hereinafter, referred to as “PTO device”) disposed on a side of the transaxle housing, and includes a connection shaft, which is interposed between the transmission and the PTO device and is extended so as to be prevented from interfering with a considerably large brake device (wet brake) provided on the axle in one of the main housing halves.

In the conventional transaxle housing, the left and right intermediate casings are laterally extended cylindrical members, which are joined at respective lateral proximal ends thereof to lateral outer openings of the respective left and right main housing halves incorporating the respective brake devices, and are fixed at respective rear portions of lateral distal ends thereof to the respective axle casings. A power take-off casing (hereinafter, referred to as “PTO casing”) of the PTO device is fixed to a front portion of the lateral distal end of one of the intermediate casings. In this way, the conventional transaxle housing expensively includes many divisional components, and requires many processes to be attached to the PTO device, thereby being disadvantageous in assembility and maintenancability.

Further, especially in the case that the axial direction of a power take-off shaft (hereinafter, “PTO shaft”) of the PTO device is different from the axial direction of the connection shaft, for instance, when the connection shaft is extended laterally of a vehicle and the PTO shaft is extended in the fore-and-aft direction of the vehicle, bevel gears or the like are disposed in the PTO casing so as to serve as a gear train for connecting the connection shaft to the PTO shaft at different angles. The gears may happen to require adjustment of backlash therebetween by adjusting shims, for instance. If the adjustment is wrong, the gears cause noise and vibration increasing power loss. However, the PTO casing of the above conventional transaxle is dividable along a dividing surface intersecting the PTO shaft, and even if the PTO casing is divided into divisional parts, the gear in one of the divisional parts is not exposed or not viewable from the outside, thereby inhibiting the gears from being easily treated.

### SUMMARY OF THE INVENTION

An object of the invention is to provide a transaxle whose transaxle housing incorporates an axle and a brake on the axle and is provided thereon with a power take-off device, wherein the transaxle housing advantageously includes divisional parts reduced in number.

To achieve the object, a transaxle according to the invention comprises: a transaxle housing including a first divisional housing member and a second divisional housing member joined to each other; a transmission disposed in the first divisional housing member; an axle disposed in the mutually joined first and second divisional housing members and drivingly connected to the transmission in the first divisional housing member; a brake device provided on the axle, wherein the second divisional housing member is formed integrally with a brake chamber portion joined to the first divisional housing member so as to incorporate the brake device; a power take-off device for taking off power from the transmission, the power take-off device including a power take-off casing; and a connection shaft interposed between the transmission and the power take-off device. The second divisional housing member is formed integrally with a mount portion expanded from the brake chamber portion radially with respect to the axle. The power take-off casing is mounted onto the mount portion. The connection shaft is passed through the mount portion between the first divisional housing member and the power take-off casing.

Therefore, the second divisional housing member incorporating the axle and the brake device also serves as a part for mounting the power take-off device and passing the connection shaft interposed between the transmission and the power take-off device without interference with the brake device, thereby reducing the number of divisional members of the transaxle housing, reducing the number of processes for assembling the transaxle housing, and reducing costs of the transaxle housing.

Preferably, the transaxle further comprises a second transmission disposed opposite to the second divisional housing member and the power take-off casing with respect to the first divisional housing member so as to be drivingly connected to the transmission in the first divisional housing member.

Therefore, the power take-off device is mounted to the transaxle housing so as to be prevented from interfering with the second transmission, such as a continuously variable belt transmission.

Preferably, the power take-off device further comprises: a gear train disposed in the power take-off casing; and a power take-off shaft disposed in the power take-off casing and connected to the connection shaft through the gear train so as to have an axis at a different angle from an axis of the connection shaft. The power take-off casing is dividable along a dividing surface disposed along the axis of the power take-off shaft.

Therefore, only by dividing the power take-off casing, the power take-off shaft and connection shaft with the gear train are easily exposed or are easily made to be visible. Thus, a backlash between gears of the gear train can be easily adjusted by adjusting shims or by another means, so as to optimize the power transmission efficiency of the gear train and prolong the life of gears.

Preferably, a fastener is disposed in the power take-off casing so as to fasten the power take-off casing to the mount portion.

Therefore, the power take-off casing has no outwardly expanded portion like a flange to be fastened by a fastener, thereby being improved in external appearance, and ensuring compactness of the transaxle with the power take-off device.

These, other and further objects, features and advantages of the invention will appear more fully from the following description with reference to accompanying drawings.

### BRIEF DESCRIPTION OF THE DRAWINGS

FIG. 1 is a skeleton diagram of a power transmission system of a four-wheel drive vehicle equipped with a rear transaxle serving as a transaxle according to the present invention.

FIG. 2 is a developed sectional rear view of the rear transaxle.

FIG. 3 is a cross sectional view taken along A-A line of FIG. 2.

FIG. 4 is a cross sectional view taken along B-B line of FIG. 2.

FIG. 5 is a cross sectional view taken along C-C line of FIG. 2.

FIG. 6 is a developed sectional rear view of the rear transaxle designed as a two-wheel drive style.

FIG. 7 is a cross sectional view taken along D-D line of FIG. 6.

### DETAILED DESCRIPTION OF THE INVENTION

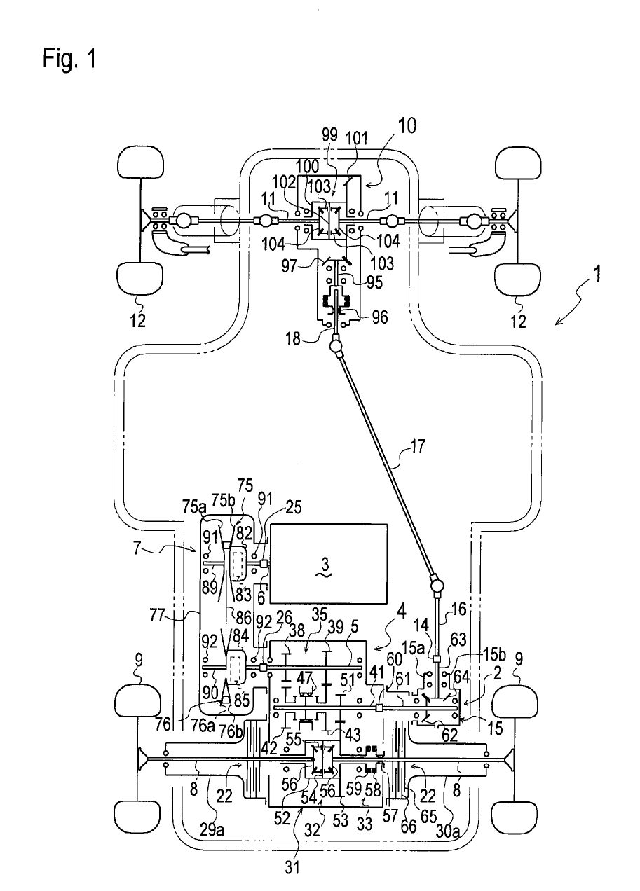

An entire structure of a four-wheel drive vehicle 1 including a rear transaxle 4 according to an embodiment will be described with reference to FIG. 1. Vehicle 1 is provided at a front portion thereof with a front transaxle 10 supporting left and right front axles 11, and at a rear portion thereof with rear transaxle 4 supporting left and right rear axles 8.

Left and right front wheels 12 are supported on outer ends of front axles 11, and left and right rear wheels 9 are supported on outer ends of rear axles 8, respectively. Left and right front wheels 12 are steerable wheels to be steered by a steering operation device, such as a steering wheel, provided in vehicle 1.

An engine 3 having an output shaft 6 is mounted in vehicle 1 between front and rear transaxles 10 and 4. In this embodiment, output shaft 6 projects horizontally leftward from engine 3.

Rear transaxle 4 includes a transaxle housing 31 supporting left and right rear axles 8 and incorporating a sub transmission 35 for driving axles 8. Rear transaxle 4 is provided with a continuously variable belt transmission (hereinafter, “CVT”) 7, serving as a main transmission, interposed between output shaft 6 of engine 3 and sub transmission 35 in transaxle housing 31. In this embodiment, CVT 7 is disposed on the left side of transaxle housing 31 (strictly, later-discussed main housing halves 27 and 28 joined to each other).

Further, rear transaxle 4 is provided with a power take-off device (hereinafter, referred to as “PTO device”) 2 for taking off power from sub transmission 35 and outputting the power to front axles 11. In this embodiment, PTO device 2 is disposed on the right side of transaxle housing 31, that is, opposite to CVT 7 with respect to transaxle housing 31 (strictly, main housing halves 27 and 28 joined to each other). Thus, vehicle 1 can be driven by driving four wheels, i.e., rear wheels 9 and front wheels 12. As discussed later, an operator can easily select the driving mode of vehicle 1 between the four-wheel drive mode and a two-wheel drive mode.

CVT 7 will be described with reference to FIG. 1. CVT 7 is extended rearward from the left end of engine 3 to the left side of transaxle housing 31. CVT 7 has a cover 77. In cover 77, a laterally horizontal drive pulley shaft 89 is journalled at opposite end portions thereof by respective bearings 91. A drive pulley 75 including a fixed pulley plate 75a and a movable pulley plate 75b is provided on drive pulley shaft 89 between bearings 91. Further, in cover 77, a laterally horizontal driven pulley shaft 90 is disposed in parallel to drive pulley shaft 89, and is journalled at opposite end portions thereof by respective bearings 92. A driven pulley 76 including a fixed pulley plate 76a and a movable pulley plate 76b is provided on driven pulley shaft 90 between bearings 92. A belt 86 is looped over drive pulley 75 (in the groove of drive pulley 75 between pulley plates 75a and 75b) and driven pulley 76 (in the groove of driven pulley 76 between pulley plates 76a and 76b).

Drive pulley 75 is provided with a drive-side pitch-radius changing device 83 in a first casing 82 provided on movable pulley plate 75b. Drive-side pitch-radius changing device 83 includes a centrifugal weight, which is adapted to be opened by centrifugal force so as to push movable pulley plate 75b toward fixed pulley plate 75a. On the other hand, driven pulley 76 is provided with a driven-side pitch-radius changing device 85 in a second casing 84 fixed to movable pulley plate 76b. Driven-side pitch-radius changing device 85 includes a spring or the like for biasing movable pulley plate 76b toward fixed pulley plate 76a.

Drive pulley shaft 89 is coaxially and detachably connected to output shaft 6 of engine 3 through a coupling 25. An input shaft 5 of sub transmission 35 is extended from transaxle housing 31 into cover 77 so as to be detachably connected to driven pulley shaft 90 through a coupling 26.

As mentioned above, CVT 7 is configured as a unit, in which cover 77 incorporates both pulley shafts 89 and 90, both pulleys 75 and 76, and first and second casings 82 and 84 incorporating respective pitch-radius changing device 83 and 85. The unit as CVT 7 can be easily detachably attached to engine 3 and transaxle housing 31 by coupling pulley shafts 89 and 90 to respective shafts 6 and 5 via respective couplings 25 and 26, so as to be interposed between engine 3 and sub transmission 35, thereby being advantageous in assembility and maintenancability.

In cover 77, each of pulley shafts 89, and 90 has the opposite ends stably supported by bearings 91 or 92 so as to ensure high torque transmission efficiency between pulleys 75 and 76. Due to this high torque transmission efficiency, belt 86 does not require a very large tension, and input pulley 5 loaded by belt 86 does not require a very large diameter. Therefore, CVT 7 requires no special coupling structure to be connected to sub transmission 35 in transaxle housing 31, while the special coupling structure would be required if input shaft 5 had a large diameter.

An operation of CVT 7 will be described. As the rotary speed of output shaft 6 of engine 3 increases, the rotary speed of drive pulley shaft 89 connected to output shaft 6 through coupling 25 increases so as to centrifugally open the weight of drive-side pitch-radius changing device 83. The centrifugally opened weight pushes movable pulley plate 75b toward fixed pulley plate 75a so as to narrow the groove of drive pulley 75 between pulley plates 75a and 75b, thereby increasing the pitch radius of drive pulley 75 (i.e., the radius of curvature of belt 86 rounding drive pulley 75). Accordingly, a portion of belt 86 in the groove of driven pulley 76 between pulley plates 76a and 76b is pulled toward drive pulley 75 so as to push movable pulley plate 76b away from fixed pulley plate 76a against the biasing force of driven-side pitch-radius changing device 85, thereby reducing the pitch radius of drive pulley 76. Consequently, the deceleration ratio of CVT 7 (between pulley shafts 89 and 90) is reduced.

As the rotary speed of output shaft 6 reduces, the rotary speed of drive pulley shaft 89 connected to output shaft 6 through coupling 25 reduces so as to centripetally close the weight of drive-side pitch-radius changing device 83, thereby withdrawing movable pulley plate 75b away from fixed pulley plate 75a. Thus, the groove of drive pulley 75 between pulley plates 75a and 75b is expanded so as to increase the pitch radius of drive pulley 75. Accordingly, the portion of belt 86 in the groove of driven pulley 76 between pulley plates 76a and 76b is pushed out by the biasing force applied on movable pulley plate 76b toward fixed pulley plate 76a, thereby increasing the pitch radius of drive pulley 76. Consequently, the deceleration ratio of CVT 7 (between pulley shafts 89 and 90) is increased.

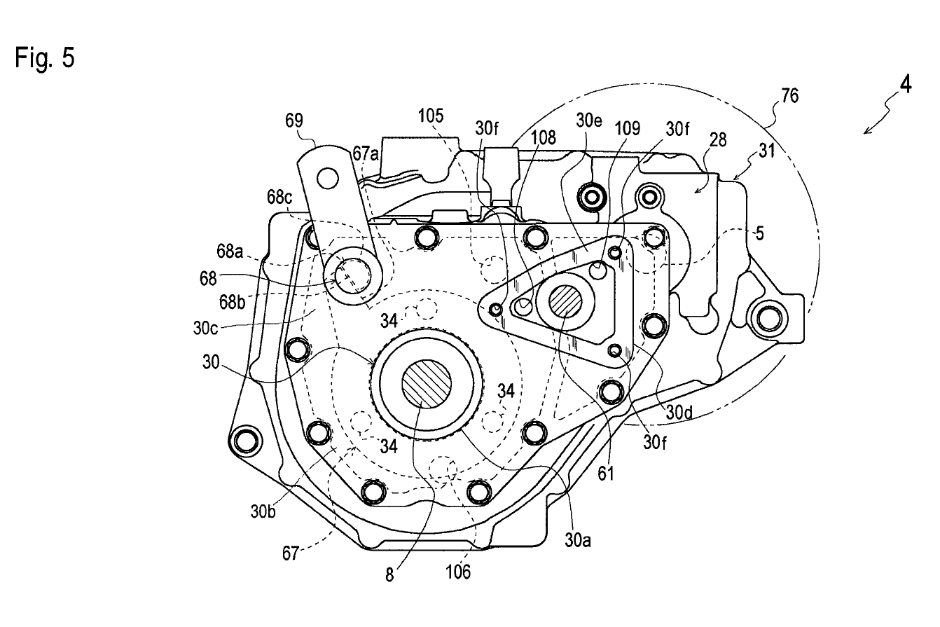

An interior configuration in transaxle housing 31 of rear transaxle 4 will now be described with reference to FIGS. 1, 2 and 5. Transaxle housing 31 (strictly, later-discussed main housing halves 27 and 28 joined to each other) has a main chamber 71 therein so as to incorporate left and right rear axles 8, a differential gear unit 32 differentially connecting axles 8 to each other, a differential lock mechanism 33 provided on differential gear unit 32, and sub transmission 35 for transmitting power from CVT 7 to differential gear unit 32.

Sub transmission 35 includes laterally horizontal input shaft 5, a laterally horizontal output shaft 41 disposed in parallel to input shaft 5, and two gear trains, i.e., a forward traveling gear train and a backward traveling gear train, interposed between input shaft 5 and output shaft 41. The rotation direction of output shaft 41 is selected between opposite directions depending on which of the gear trains is selected.

In transaxle housing 31, input shaft 5 is formed thereon integrally (or fixedly provided thereon) with a backward traveling drive gear 38 and a forward traveling drive gear 39, and output shaft 41 is relatively rotatably provided thereon with a backward traveling driven gear 42 and a forward traveling driven gear 43. Forward traveling drive gear 39 and forward traveling driven gear 43 mesh with each other so as to constitute the forward traveling gear train. Backward traveling drive gear 38 and backward traveling driven gear 42 mesh with each other through a reverse gear (not shown) freely rotatably provided in transaxle housing 31, so as to constitute the backward traveling gear train.

A spline hub 46 is relatively unrotatably fitted on output shaft 41 between driven gears 42 and 43, and a clutch slider 47 is relatively unrotatably and axially slidably fitted on spline hub 46 so as to selectively mesh with one of driven gears 42 and 43 due to the axial slide thereof, thereby selectively applying either normal or reverse rotation to output shaft 41. Further, clutch slider 47 is provided with a neutral position in the slide direction thereof where it meshes with none of gears 42 and 43.

A clutch fork shaft (not shown) is axially slidably provided in transaxle housing 31, and is connected to clutch slider 47 and to a sub-transmission operation device (not shown), such as a lever, provided on vehicle 1. Due to manipulation of the sub-transmission operation device, clutch slider 47 slides to be set at one of a backward traveling position, a neutral position and a forward traveling position. A detent mechanism may be provided on the clutch fork shaft or another so as to hold clutch slider 47 at the set position. A portion of output shaft 41 adjacent to one end thereof is formed (or fixedly provided) thereon with an output gear 51 for transmitting the rotation of output shaft 41 to differential gear unit 32.

Differential gear unit 32 includes a differential cage 52, a bull gear 53, a pinion shaft 54, a pair of bevel pinions 55, and a pair of left and right bevel differential side gears 56. Differential cage 52 is a hollow member disposed in transaxle housing 31 so as to accommodate proximal end portions of coaxial axles 8. Bull gear 53, serving as an input gear of differential gear unit 32, is peripherally fixed on differential cage 52 and meshes with output gear 51 on output shaft 41. Pinion shaft 54 is disposed in differential cage 52 between the proximal ends of axles 8, and is extended perpendicular to axles 8, so as to be rotatably integral with differential cage 52. Bevel pinions 55 are relatively rotatably disposed on pinion shaft 54 opposite to each other. Alternatively, only one pinion 55 may be provided on pinion shaft 54. Bevel differential side gears 56 are fixed on the proximal end portions of respective axles 8 in differential cage 52. Each of bevel differential side gears 56 meshes with both bevel pinions 55.

Differential lock mechanism 33 includes a differential lock slider 57 axially slidably fitted on one of axles 8. An engagement part 58 is fixed to differential lock slider 57, and an engagement part 59 is fixed to bull gear 53.

A differential lock operation device (not shown), such as a lever, is provided on vehicle 1, and is connected to differential lock slider 57 operably for axially sliding differential lock slider 57 between a differential position and a differential lock position. Due to the axial slide of differential lock slider 57 on axle 8, when differential lock slider 57 is disposed at the differential lock position, engagement part 58 is engaged to engagement part 59 so as to lock axles 8 to bull gear 53, and when differential lock slider 57 is disposed at the differential position, engagement part 58 is disengaged from engagement part 59 so as to allow the differential rotation of axles 8.

A pair of left and right friction brake devices 22, preferably, wet brakes, are provided around respective left and right axles 8, and are operatively connected to a brake operation device (not shown), such as a pedal, provided on vehicle 1. Each brake device 22 includes first friction disks 65 and second friction disks 66 alternately aligned (in each of later-discussed brake chamber portions 29b and 30b of axle casings 29 and 30). In each brake device 22, first friction disks 65 are relatively unrotatably fitted to axle 8, and second friction disks 66 are relatively unrotatably fitted to transaxle housing 31 (strictly, each of brake chamber portions 29b and 39b of axle casings 29 and 30).

In each brake device 22, a pressure ring 67 is axially slidably and relatively rotatably fitted on a part of transaxle housing 31 (each of later-discussed main housing halves 27 and 28) axially inside of the alignment of friction disks 65 and 66. Transaxle housing 31 (later-discussed main housing halves 27 and 28) is formed with walls facing respective pressure rings 67. In each brake device 22, a cam ball 34 is disposed between the wall and pressure ring 67, so as to constitute a brake cam mechanism 70 so as to alter the rotation of pressure ring 67 into the axial thrust of pressure ring 67.

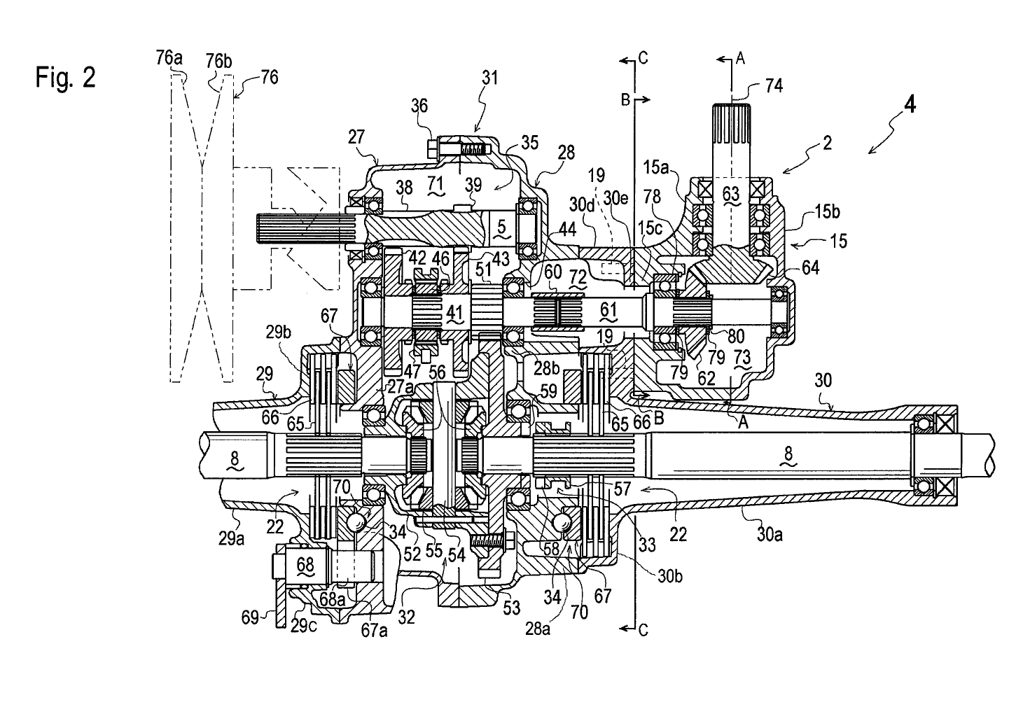

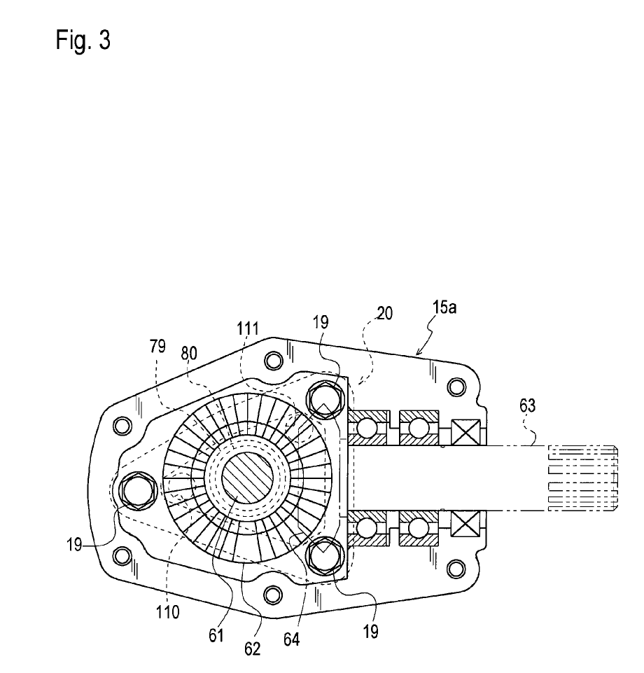

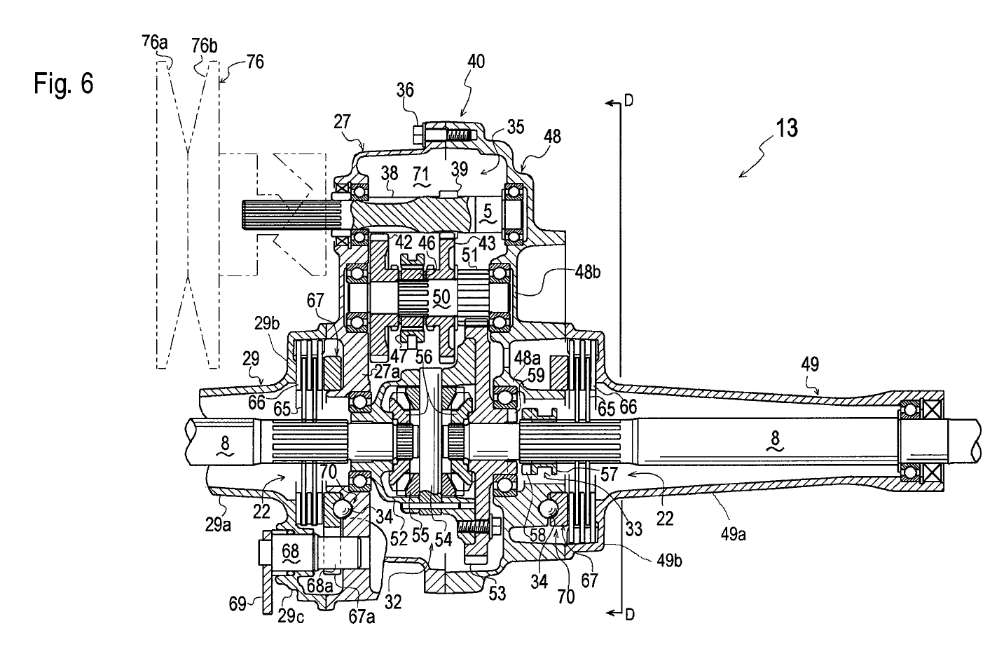

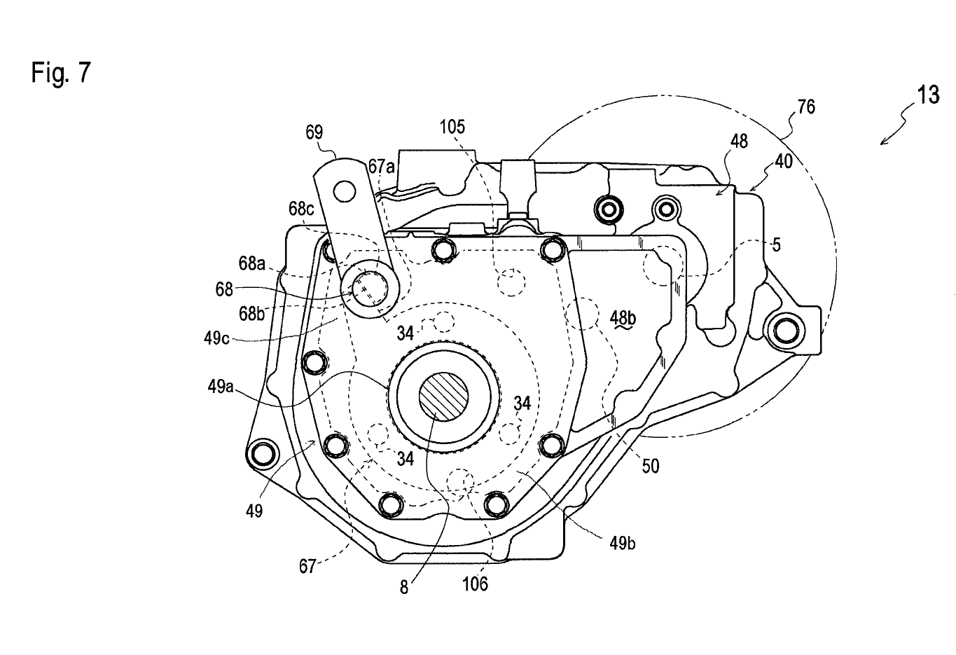

Each pressure ring 67 has an arm 67a extended therefrom. A pair of left and right horizontal brake camshafts 68 are rotatably supported by transaxle housing 31 (strictly, later-discussed axle casings 29 and 30) and are disposed in parallel to axles 8. In transaxle housing 31, an inner end portion of each brake camshaft 68 is formed into a sectionally semicircular portion 68a, which has opposite edges 68c and a flat surface 68b between edges 68c. Each brake camshaft 68 projects at an outer end thereof outward from transaxle housing 31 so as to be fixedly provided thereon with a brake control arm 69. In this regard, FIG. 2 illustrates only representative left brake camshaft 68 and arm 67a of pressure ring 67 of left brake device 22, and FIG. 3 illustrates only representative right brake camshaft 68 and arm 67a of pressure ring 67 of right brake device 22. However, brake camshaft 68 and arm 67a on one side shown in each of FIGS. 2 and 3 suggest appearance of unshown brake camshaft 68 and arm 67a on the other side. The same is stated about later-discussed FIGS. 6 and 7.

In this brake structure, when brake control arms 69 are rotated for braking by operating the brake operation device, e.g., by depressing the brake pedal, each brake camshaft 68 rotates so as to tilt flat surface 68b relative to corresponding arm 67a and to press edge 68c against arm 67a, thereby pushing arm 67a and rotating pressure ring 67. In each brake device 22, due to cam mechanism 70, rotated pressure ring 67 is axially thrust so as to press friction disks 65 and 66 against one another between pressure ring 67 and a wall of transaxle housing 31, thereby braking corresponding axle 8.

Output shaft 41 is connected at one end thereof (in this embodiment, the right end opposite to CVT 7) to a coaxial (i.e., laterally horizontal) connection shaft 61 through a coupling 60 rotatably integrally with connection shaft 61. Connection shaft 61 is extended from a side surface of transaxle housing 31 into a power take-off casing (hereinafter referred to as “PTO casing”) 15 of PTO device 2. PTO casing 15 is fixed on the side surface of transaxle housing 31 so as to cantilever from transaxle housing 31. In PTO casing 15, a bevel gear 62 is fixed on connection shaft 61. A power take-off shaft (hereinafter, referred to as “PTO shaft”) 63 is disposed in the fore-and-aft direction of vehicle 1, and is supported by PTO casing 15. In PTO casing 15, a bevel gear 64 is fixed on a rear end of PTO shaft 63, and meshes with bevel gear 62. In this way, PTO casing 15, PTO shaft 63, and bevel gears 62 and 64 constitute PTO device 2 for outputting power to front transaxle 10, and connection shaft 61 transmits the rotation of output shaft 41 of sub transmission 35 to PTO shaft 63 through the gear train of bevel gears 62 and 64.

Transaxle housing 31 and PTO casing 15 are configured and disposed in consideration of the existence of brake device 22 adjacent to PTO device 2, as discussed later.

PTO shaft 63 projects forward from PTO casing 15 so as to be connected to a first propeller shaft 16 through a coupling 14. First propeller shaft 16 is extended in the fore-and-aft direction of vehicle 1, and is disposed on a lateral side (in this embodiment, a right side) of engine 3 opposite to CVT 7. An input shaft 18 of front transaxle 10 projects rearward in front of engine 3. A second propeller shaft 17 is extended slantwise in plan view, and is interposed between first propeller shaft 16 and input shaft 18 of front transaxle 10 through universal joints. In this way, PTO device 2 takes off a part of power of rear transaxle 4 (sub transmission 35) and transmits the part of power to front transaxle 10.

Front transaxle 10 will be described with reference to FIG. 1. Input shaft 18 is extended in the fore-and-aft direction of vehicle 1, and a clutch shaft 95 is coaxially extended forward from input shaft 18. A clutch is interposed between input shaft 18 and clutch shaft 95. The clutch includes a clutch slider 96 which is axially slidably fitted on input shaft 18 so as to engage or disengage with and from clutch shaft 95. Vehicle 1 is provided with a drive mode selection operation device (not shown), such as a lever, operatively connected to clutch slider 96. Due to manipulation of the drive mode selection operation device, clutch slider 96 is switchable between a clutch-on position for engaging with clutch shaft 95, i.e., a four-wheel drive mode position, and a clutch-off position for disengaging from clutch shaft 95, i.e., a two-wheel drive mode position.

In front transaxle 10, a bevel gear 97 is fixed on a front end of clutch shaft 95, and meshes with a bull gear 101 serving as an input gear of a differential gear unit 99 differentially connecting left and right front axles 11. Similar to differential gear unit 32, differential gear unit 99 includes a differential cage 100, bull gear 101, a pinion shaft 102, a pair of bevel pinions 103, and a pair of bevel differential side gears 104, so as to correspond to differential cage 52, bull gear 53, pinion shaft 54, bevel pinions 55 and bevel differential side gears 56, respectively. However, differential gear unit 99 is provided with no differential lock mechanism. Alternatively, differential gear unit 99 may be provided with a differential lock mechanism.

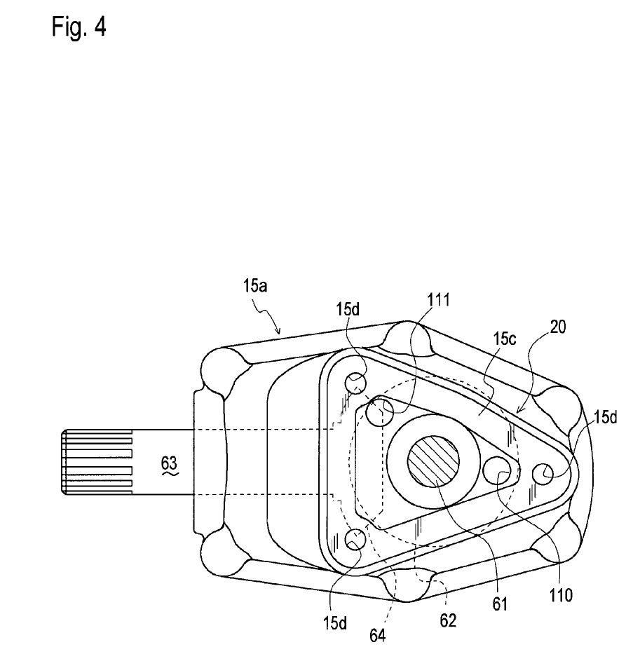

Transaxle housing 31 will be described with reference to FIGS. 2 to 5. Transaxle housing 31 includes a pair of left and right main housing halves 27 and 28 and a pair of left and right axle casings 29 and 30, and is connected to PTO casing 15. Left and right main housing halves 27 and 28 are joined to each other by bolts 36. Left axle casing 29 is joined to a laterally distal (left) end surface of left main housing half 27, and right axle casing 30 is joined to a laterally distal (right) end surface of right main housing half 28. PTO casing 15 is joined to one of axle casings 29 and 30. In this embodiment, PTO casing 15 is joined to right axle casing 30.

Left main housing half 27 is formed therein with a partition wall 27a, and right main housing half 28 is formed therein with a partition wall 28a, so as to ensure main chamber 71 in mutually joined left and right main housing halves 27 and 28 between partition walls 27a and 28a. As mentioned above, sub transmission 35, differential gear unit 32, differential lock mechanism 33, and the proximal ends of left and right rear axles 8 are disposed in main chamber 71.

Left and right axle casings 29 and 30 are formed integrally with axle covering portions 29a and 30a extended laterally outward so as to cover axially intermediate main portions of respective axles 8. Left and right axle casings 29 and 30 are formed integrally with respective brake chamber portions 29b and 30b at laterally proximal end portions thereof to be joined to respective main housing halves 27 and 28. Brake chamber portions 29b and 30b are expanded radially with respect to axles 8 so as to be diametrically larger than axle covering portions 29a and 30a. Thus, left and right axle casings 29 and 30 are trumpet-shaped in rear view. Left and right brake devices 22 are disposed around respective axles 8 in respective brake chamber portions 29b and 30b on lateral outsides of respective partition walls 27a and 28a of main housing halves 27 and 28. Brake chamber portions 29b and 30b have respective portions further expanded therefrom radially with respect to axles 8 so as to form brake-shaft support portions 29c and 30c for supporting respective brake camshafts 68.

Partition wall 28a of right main housing half 28 is further extended so as to form a partition wall 28b, and a rightward (laterally distally) opened recess is formed in right main housing half 28 on the right side of partition wall 28b. Partition wall 28b has a hole opened to the recess so as to pass output shaft 41 therethrough between main chamber 71 and a later-discussed shaft-connection chamber 72. Brake chamber portion 30b of right axle casing 30 has a portion further expanded therefrom radially with respect to axle 8 so as to form a mount portion 30d for covering the outer opening of the recess in right main housing part 28 on the lateral outside of partition wall 28b.

Mount portion 30d has a vertical side surface at a laterally distal end thereof, such as to serve as a partition wall 30e to which PTO casing 15 (i.e., a later-discussed casing part 15a) of PTO device 2 is fitted. Mount portion 30d of right axle casing 30 is joined to right main housing half 28 so as to have a shaft-connection chamber 72 therein between partition walls 28b and 30e. Partition wall 30e has an opening for passing connection shaft 61 therethrough between shaft-connection chamber 72 and a later-discussed power take-off chamber 73. Coupling 60 connecting output shaft 41 and connection shaft 61 to each other is disposed in shaft-connection chamber 72.

Due to this structure, only right axle casing 30 with no additional member has the space therein for passing connection shaft 61 and the portion for mounting PTO device 2 while it incorporates brake device 22 prevented from interfering with connection shaft 61 and PTO device 2. Therefore, the number of divisional parts constituting transaxle housing 31 can be reduced.

PTO casing 15 is dividable into left and right divisional casing parts 15a and 15b along a dividing surface 74 disposed along the center axis of PTO shaft 63. PTO casing 15 is provided therein with a power take-off chamber (hereinafter, referred to as “PTO chamber”) 73 between casing parts 15a and 15b so as to incorporate the distal end portion of connection shaft 61 and bevel gears 62 and 64.

Casing part 15a has a wall 15c fitted to partition wall 30e of mount portion 30d of axle casing 30. Wall 15c has an opening opened to shaft-connection chamber 72, and supports a bearing 78 between chambers 72 and 73 so as to journal an intermediate portion of connection shaft 61. In PTO chamber 73, bevel gear 62 is spline-fitted on connection shaft 61, and a retaining ring 80 is fixed on connection shaft 61. Shims 79 are provided on connection shaft 61 to fill up a gap between bearing 78 and bevel gear 62, and a gap between bevel gear 62 and retaining ring 80, so as to optimize the backlash between bevel gears 62 and 64, thereby reducing noise and vibration and optimizing the power transmission efficiency.

Casing part 15b can be separated from casing part 15a along dividing surface 74, i.e., along the axis of PTO shaft 63, so as to expose the outer opening of casing part 15a and make bevel gear 62 and its surroundings visible and treatable. Therefore, only by removing casing part 15b, shims 79 can be easily adjusted so as to optimize the backlash between bevel gears 62 and 64.

Bolt holes 15d are bored through wall 15c of casing part 15a to be fitted to partition wall 30e, and bolt holes 30f are bored in partition wall 30e so as to correspond to respective bolt holes 15d. Bolt holes 15d are opened at outer ends thereof into PTO chamber 73 in casing part 15a. While casing part 15b is removed, bolts 19 serving as fasteners are screwed into respective bolt holes 15d and bolt holes 30f, so as to fasten casing part 15a to partition wall 30e of axle casing 30. In other words, PTO device 2 is provided with a fixture portion 20 including wall 15c and bolt holes 15d so as to be fixed to axle casing 30. Fixture portion 20 is not disposed at an outer portion of PTO casing 15 in a flange-like shape, but it is disposed in PTO casing 15 so as to ensure compactness of PTO device 2 and axle casing 30.

Fluid holes 105 and 106 penetrate partition wall 28b of right main housing half 28 so as to be interposed between chambers 71 and 72. Fluid holes 108 and 109 penetrate partition wall 30e of axle casing 30, and fluid holes 110 and 111 penetrate wall 15c of casing part 15a of PTO casing 15 so as to be connected coaxially to respective fluid holes 108 and 109, so that a fluid passage made of joined fluid holes 108 and 110 and a fluid passage made of joined fluid holes 109 and 111 are interposed between chambers 72 and 73.

Main chamber 71 is filled with fluid serving as lube for the gears therein. When the fluid in main chamber 71 is agitated by rotating gears, the agitated fluid can flow into shaft-connection chamber 72 through fluid holes 105 and 106. Further, the fluid in shaft-connection chamber 72 can flow into PTO chamber 73 through the fluid passages made of fluid holes 108 and 110 and of fluid holes 109 and 111. Thus, members in respective chambers 71, 72 and 73 can be lubricated by fluid flowing among chambers 71, 72 and 73 through these fluid passages, and no additional lube supply device is required, thereby reducing the number of parts and costs, and improving assembility and maintenancability.

Referring to FIGS. 2, 6 and 7, description will be given of a rear transaxle 13 including a transaxle housing 40 according to a second embodiment, serving as rear transaxle 4 including transaxle housing 31 modified correspondingly to design change of vehicle 1 from the four-wheel drive style to a two-wheel drive style. In comparison with the first embodiment shown in FIGS. 1 to 5, the same components and portions are designated by the same reference numerals.

Rear transaxle 13 shown in FIGS. 6 and 7 is designed for a two-wheel drive vehicle. Transaxle housing 40 of transaxle 13 includes mutually joined left and right main housing halves 27 and 48 and left and right axle casings 29 and 49 joined to laterally outer ends of respective main housing halves 27 and 48. Rear transaxle 13 does not require PTO device 2 required for rear transaxle 4. Thus, transaxle housing 40 is not designed to be connected to PTO casing 15.

Sub transmission 35 in transaxle housing 40 of transaxle 13 includes an output shaft 50 corresponding to output shaft 41 of transaxle 4, however, output shaft 50 is shorter than output shaft 41, so as to be entirely disposed in mutually joined left and right main housing halves 27 and 48. That is, output shaft 50 is journalled at a right end thereof by a partition wall 48b of right main housing half 48 through a bearing.

In this regard, right main housing half 48 is almost identical to right main housing half 28. That is, right main housing half 48 includes partition walls 48a and 48b corresponding to respective partition walls 28a and 28b of right main housing half 28. The only different point of main housing half 48 from main housing half 28 is that partition wall 48b is closed, i.e., partition wall 48b has no hole for passing a shaft therethrough, because rear transaxle 13 is not provided with PTO device 2, and no connection shaft is required for drivingly connecting output shaft 50 to PTO device 2. In other words, main housing half 48 for the two-wheel drive vehicle can be easily changed into main housing half 28 for the four-wheel drive vehicle only by boring partition wall 48b, thereby improving standardization of the transaxle housing, and reducing costs.

Further, in transaxle housing 40, right axle casing 49 includes an axle covering portion 49a, a brake chamber portion 49b and a brake-shaft support portion 49c, corresponding to axle covering portion 30a, brake chamber portion 30b and brake-shaft support portion 30c of right axle casing 30. However, right axle casing 49 has no portion corresponding to mount portion 30d because it requires no portion for mounting PTO casing 15 and passing a connection shaft to be drivingly connected to PTO device 2. Consequently, left and right axle casings 29 and 49 can be shaped laterally symmetrically, thereby improving standardization of the transaxle housing, and reducing costs.

It is further understood by those skilled in the art that the foregoing description is a preferred embodiment of the disclosed device and that various changes and modifications may be made in the invention without departing from the scope thereof defined by the following claims.

What is claimed is:

1. A transaxle comprising:
a transaxle housing including a first divisional housing member and a second divisional housing member joined to each other;
a transmission disposed in the first divisional housing member;
an axle disposed in the mutually joined first and second divisional housing members and drivingly connected to the transmission in the first divisional housing member;
a brake device provided on the axle, wherein the second divisional housing member is formed integrally with a brake chamber portion joined to the first divisional housing member so as to incorporate the brake device in the brake chamber portion;
a power take-off device for taking off power from the transmission, the power take-off device including a power take-off casing; and
a connection shaft interposed between the transmission and the power take-off device, wherein the second divisional housing member is formed integrally with a mount portion expanded from the brake chamber portion radially with respect to the axle, wherein the power take-off casing is mounted onto the mount portion, and wherein the connection shaft is passed through the mount portion between the first divisional housing member and the power take-off casing.

2. The transaxle according to claim 1, further comprising:
a second transmission disposed opposite to the second divisional housing member and the power take-off casing with respect to the first divisional housing member so as to be drivingly connected to the transmission in the first divisional housing member.

3. The transaxle according to claim 1, the power take-off device further comprising:
a gear train disposed in the power take-off casing; and
a power take-off shaft disposed in the power take-off casing and connected to the connection shaft through the gear train so as to have an axis at a different angle from an axis of the connection shaft, wherein the power take-off casing is dividable along a dividing surface disposed along the axis of the power take-off shaft.

4. The transaxle according to claim 1, further comprising:
a fastener disposed in the power take-off casing so as to fasten the power take-off casing to the mount portion.
